(19) United States
(12) Patent Application Publication
(10) Pub. No.: US 2013/0235314 A1
(43) Pub. Date: Sep. 12, 2013

(54) SUBSTRATE AND LIQUID CRYSTAL DISPLAY DEVICE

(71) Applicant: Hiroyuki Moriwaki, Osaka-shi (JP)

(72) Inventor: Hiroyuki Moriwaki, Osaka-shi (JP)

(73) Assignee: SHARP KABUSHIKI KAISHA, Osaka-shi, Osaka (JP)

(21) Appl. No.: 13/883,317

(22) PCT Filed: Nov. 24, 2011
(86) PCT No.: PCT/JP2011/076992

§ 371 Date: May 3, 2013

(30) Foreign Application Priority Data
Nov. 30, 2010 (JP) 2010-267243

(51) Int. Cl. G02F 1/1337

(52) U.S. Cl. CPC G02F 1/1337
USPC 349/124; 428/156

(57) ABSTRACT

An object of the invention is to improve the accuracy of positioning a supplied thin-film material on a substrate surface. A region corresponding to a glass substrate in a mother glass is defined as a thin-film-formed region. An alignment mark is disposed outside the thin-film-formed region. The alignment mark serves as a position identifier for identifying a position where a droplet of a thin-film material (for example, a droplet of an alignment film material is to be dropped. The alignment mark includes a depression-protrusion shape in which a plurality of island-like depressions or protrusions are two-dimensionally arranged. In the depression-protrusion shape, a coordinate system indicating respective positions of the depressions or protrusions is defined. In a part of the depression-protrusion shape, a marking to which the alignment film material is fed is formed. The invention is applicable for example to a liquid crystal display device.

### TECHNICAL FIELD

The present invention relates to a substrate and a liquid crystal display device, and particularly to a substrate having a surface on which a thin film is formed as well as a liquid crystal display device in which the substrate is used.

### BACKGROUND ART

A liquid crystal display device commonly has a structure in which a liquid crystal layer is encapsulated between a pair of substrates. Of the pair of substrates, one substrate is a TFT (Thin-Film Transistor) substrate on which components such as a plurality of gate lines, a plurality of source lines, a plurality of pixel electrodes, and a plurality of TFTs are formed. The other substrate of the pair of substrates is an opposite substrate on which a common electrode shared by a plurality of pixel electrodes is formed. The liquid crystal layer between the TFT substrate and the opposite substrate is surrounded and thereby encapsulated by a frame-like seal member.

In the above-described pair of substrates, a pixel region serving as a display region and a border region serving as a non-display region provided around the outer perimeter of the pixel region are formed. The border region of the TFT substrate includes a seal-member-formed region and a terminal region provided around the outer perimeter of the seal-member-formed region. In the terminal region, a plurality of terminals are formed for providing a signal to the pixel region.

The TFT substrate and the opposite substrate each have a surface facing the liquid crystal layer and provided with an alignment film for regulating the alignment of liquid crystal molecules in the liquid crystal layer. The alignment film is formed as a film of a resin such as polyimide for example and has its surface rubbed or photo-aligned to gain an alignment ability.

The alignment film is formed in the following way. Liquid polyimide is applied to the surface of the TFT substrate and the opposite substrate and thereafter baked and accordingly cured. Polyimide can be applied in accordance with, for example, the inkjet printing method. A conventional technology of using the inkjet printing method to emit droplets of an alignment film onto a substrate is disclosed, for example, in Japanese Patent Laying-Open No. 2006-320839 (PTD 1).

### CITATION LIST

### Patent Document

PTD 1: Japanese Patent Laying-Open No. 2006-320839

### SUMMARY OF INVENTION

### Technical Problem

It is necessary, for a process of forming an alignment film by means of the inkjet method, to make relatively low the viscosity of an alignment film material such as polyimide, so that the alignment film material emitted toward and landing onto a substrate spreads sufficiently on the surface of the substrate. A low-viscosity alignment film material is easy to spread on a substrate surface and is therefore likely to spread into a border region where the alignment film is not intended to be formed because the alignment film is unnecessary for the border region.

Meanwhile, the liquid crystal display device is required to have a slim border, namely a slimmed border region around the outer perimeter of the display region. In order to achieve a slim border of the liquid crystal display device, it is necessary to reduce the distance between the seal member disposed in the border region and the pixel region. If the above-described low-viscosity alignment film material spreads into the border region to reach the seal-member-formed region, the seal member and the alignment film material overlap each other. If the seal member and the alignment film material overlap each other, the adhesion between the seal member and the substrate is weakened and accordingly the outside air enters the liquid crystal layer from the interface between the seal member and the substrate. It is therefore considered important to accurately apply the alignment film material to the substrate and prevent overlapping of the seal member and the alignment film material.

The present invention has been made in view of the above problem, and a chief object of the invention is to provide a substrate for which the accuracy of positioning, on a surface of a substrate, a thin-film material applied onto the substrate surface can be improved. Another object of the present invention is to provide a liquid crystal display device in which this substrate is used.

### Solution to Problem

A substrate according to the present invention has a surface with a thin film to be formed on the surface, the substrate includes a depression-protrusion shape in which a plurality of island-like depressions or protrusions formed in the surface are two-dimensionally arranged, and a marking to which a thin-film material forming the thin film is fed is formed in a part of the depression-protrusion shape.

Regarding the substrate, preferably the depression-protrusion shape is formed by depressing a part of the surface.

Regarding the substrate, preferably the depression-protrusion shape is formed by protruding a part of the surface.

The substrate preferably has a thin-film-formed region where the thin film is to be formed on the substrate, and a positional identifier is disposed outside the thin-film-formed region.

Regarding the substrate, preferably a coordinate system indicating respective positions of a plurality of island-like depressions or protrusions is defined in the depression-protrusion shape.

A liquid crystal display device according to the present invention includes: a pair of substrates disposed opposite to each other; and a liquid crystal layer disposed between the pair of substrates. The substrates each include a display region where an image is to be displayed and a border region around an outer perimeter of the display region. The substrates each have a surface facing the liquid crystal layer and an alignment film which is a cured form of an alignment film material having flowability is formed on the surface. The surface of at least one of the pair of substrates has a depression-protrusion shape in which a plurality of island-like depressions or protrusions are two-dimensionally arranged. A marking to which the alignment film material forming the alignment film is fed is formed in a part of the depression-protrusion shape.

### Advantageous Effects of Invention

With the substrate of the present invention, the accuracy of positioning the applied thin-film material on the substrate surface can be improved.

### BRIEF DESCRIPTION OF DRAWINGS

FIG. 1 is a cross-sectional view showing a general configuration of a liquid crystal display device in a first embodiment.

FIG. 2 is a plan view of the liquid crystal display device shown in FIG. 1.

FIG. 3 is a cross-sectional view showing, in an enlarged form, a part of a TFT substrate.

FIG. 4 a plan view showing, in an enlarged form, a part of the TFT substrate.

FIG. 5 is a cross-sectional view showing, in an enlarged form, a support structure in the TFT substrate.

FIG. 6 is a plan view showing, in an enlarged form, a part of an opposite substrate.

FIG. 7 is a cross-sectional view of the part of the opposite substrate along a line VII-VII shown in FIG. 6.

FIG. 8 is a schematic diagram of a mother glass from which the TFT substrate is formed.

FIG. 9 is an enlarged view of a region IX shown in FIG. 8.

FIG. 10 is a cross-sectional view of an alignment mark along a line X-X shown in FIG. 9.

FIG. 11 is a schematic diagram showing a state where a droplet of a thin-film material is being dropped onto the alignment mark shown in FIGS. 8 to 10.

FIG. 12 is a schematic diagram showing the thin-film material attaching to the alignment mark.

FIG. 13 is a schematic diagram of a mother glass from which the opposite substrate is formed.

FIG. 14 is an enlarged view of a region XIV shown in FIG. 13.

FIG. 15 is a cross-sectional view of an alignment mark along a line XV-XV shown in FIG. 14.

FIG. 16 is a schematic diagram showing a state where a droplet of a thin-film material is being dropped onto the alignment mark shown in FIGS. 13 to 15.

FIG. 17 is a schematic diagram showing the thin-film material attaching to the alignment mark.

FIG. 18 is a schematic diagram showing a target position in the alignment mark on which the droplet is to be dropped and a landing position therein onto which the droplet has landed.

FIG. 19 is a cross-sectional view showing a general configuration of a liquid crystal display device in a second embodiment.

### DESCRIPTION OF EMBODIMENTS

Embodiments of the present invention will hereinafter be described based on the drawings. In the following drawings, the same or corresponding components are denoted by the same reference numerals, and a description thereof will not be repeated.

### First Embodiment

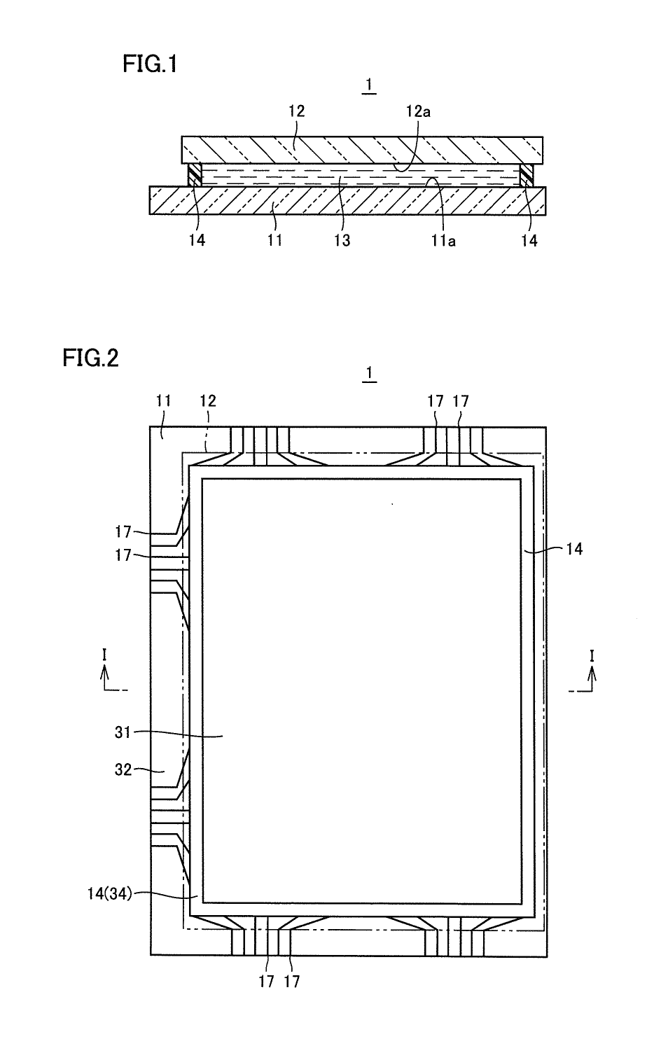

FIG. 1 is a cross-sectional view showing a general configuration of a liquid crystal display device 1 in a first embodiment. FIG. 2 is a plan view of liquid crystal display device 1 shown in FIG. 1. FIG. 1 is a cross-sectional view of liquid crystal display device 1 along a line I-I shown in FIG. 2. As shown in FIGS. 1 and 2, liquid crystal display device 1 includes a TFT substrate 11 as a first substrate, an opposite substrate 12 as a second substrate disposed opposite to TFT substrate 11, and a liquid crystal layer 13 provided between TFT substrate 11 and opposite substrate 12. A pair of TFT substrate 11 and opposite substrate 12 is disposed so that they are opposite to each other. Liquid crystal layer 13 is disposed between the pair of TFT substrate 11 and opposite substrate 12.

Liquid crystal display device 1 also includes a seal member 14 provided between TFT substrate 11 and opposite substrate 12. As shown in FIG. 2, seal member 14 is formed in the shape of a generally rectangular frame, and surrounds and thereby seals liquid crystal layer 13. Seal member 14 is formed, for example, of a UV/thermosetting resin such as acrylic or epoxy-based resin. In seal member 14, a plurality of spacers and electrically-conductive particles (not shown) are mixed so that they are dispersed therein. Seal member 14 has a line width, for example, of approximately 0.5 mm to 2.5 mm.

TFT substrate 11 and opposite substrate 12 each include a pixel region 31 as a display region where an image is to be displayed and a border region 32 as a non-display region which is a region around the outer perimeter of pixel region 31. Border region 32 includes a seal-member-formed region 34 (region in which seal member 14 is formed) provided at a predetermined distance from pixel region 31. In border region 32, a plurality of leads 17 are formed. Lead 17 has a line width of approximately 10 μm. The interval between leads 17 adjacent to each other is approximately 20 μm in seal-member-formed region 34.

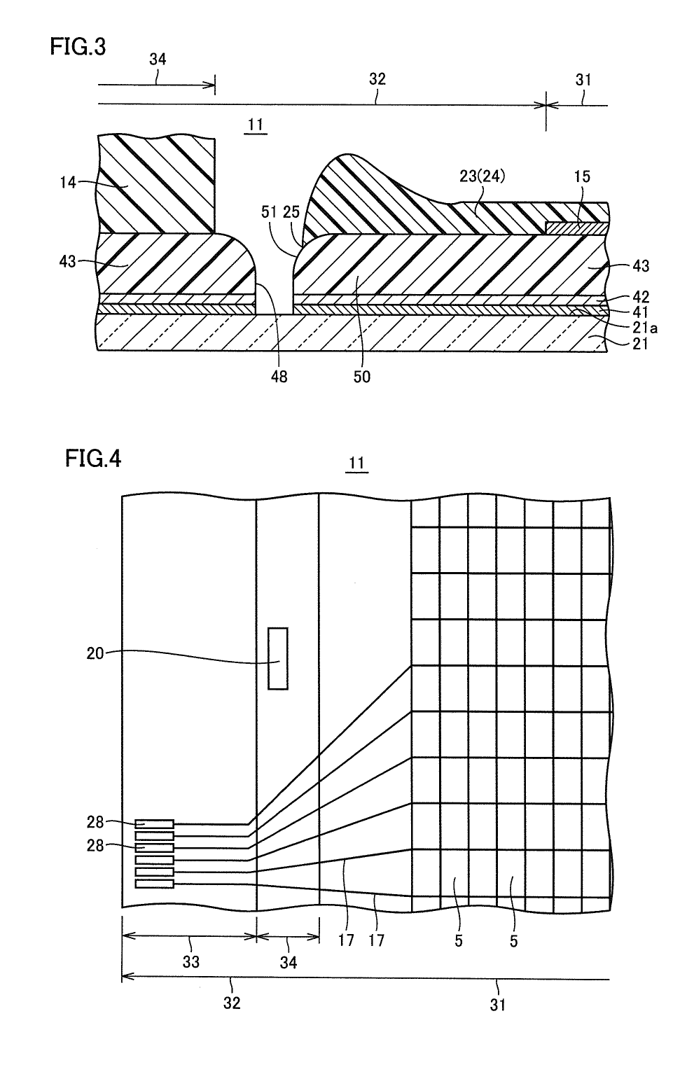

FIG. 3 is a cross-sectional view showing, in an enlarged form, a part of TFT substrate 11. FIG. 4 a plan view showing, in an enlarged form, a part of TFT substrate 11. In FIG. 4, an alignment film 23 and a depression 48, which will be described later herein, are not shown.

Border region 32 of TFT substrate 11 has, as shown in FIG. 4, a terminal region 33 which is a region opposite to pixel region 31 with respect to seal-member-formed region 34. Terminal region 33 is formed, as shown in FIG. 2, in a lateral side region of TFT substrate 11. In terminal region 33, a plurality of terminals 28 are formed for providing a signal to pixel region 31.

In seal-member-formed region 34 of TFT substrate 11 as shown in FIG. 4, a pad 20 is formed as a stacked electrode made up of a conductive film and a transparent conductive film such as ITO (Indium Tin Oxide). A plurality of pads 20 are formed on a surface of a planarization film 43 shown in FIG. 3. Pad 20 is formed so that its ITO having a thickness of approximately 100 nm is connected, via a through hole made in an underlying insulating layer, to a line of an underlying layer. Pads 20 are arranged at predetermined intervals along seal member 14. Pad 20 is used for electrically connecting to a common electrode 26 of opposite substrate 12 via electrically conductive particles of seal member 14.

In pixel region 31 of TFT substrate 11, a plurality of pixels 5 are arranged in the form of a matrix. At pixels 5, pixel electrodes 15 each formed of a transparent conductive film such as ITO are formed, respectively. At pixels 5, TFTs (not shown) connected to pixel electrodes 15 and serving as switching elements are also formed, respectively. Further, in TFT substrate 11, lines such as gate lines and source lines (not shown) connected to the TFTs are formed.

TFT substrate 11 as shown in FIG. 3 has a glass substrate 21 which is a support substrate. This glass substrate 21 has a surface 21a on the liquid crystal layer 13 side, and a gate insulating film 41 covering the gate lines (not shown) is formed on surface 21a. Gate insulating film 41 is formed for example of SiN or an oxide film such as SiO₂ with a thickness of approximately 0.4 μm. A plurality of leads 17 are made of the same material as the gate lines, and terminals 28 are provided at respective ends of leads 17. The source lines are connected to leads 17.

Gate insulating film 41 has a surface on which a passivation film 42 serving as a protective film is formed. Passivation film 42 is formed for example of an inorganic film such as SiN with a thickness of approximately 0.25 μm. Passivation film 42 has a surface on which planarization film 43 is formed that is an insulating film covering passivation film 42. Planarization film 43 is made for example of a photo-setting acrylic resin and formed to have a thickness of approximately 2.5 μm.

In pixel region 31, a plurality of above-described pixel electrodes 15 are formed on the surface of planarization film 43. In seal-member-formed region 34, seal member 14 is formed on the surface of planarization film 43. A part of planarization film 43 forms a support structure 50 which supports alignment film 23 and an alignment film material 24.

On the liquid crystal layer 13 side of TFT substrate 11, alignment film material 24 having flowability is cured to form alignment film 23 which is formed to spread from pixel region 31 toward the region where seal member 14 is formed. In other words, surface 11a (see FIG. 1), on the liquid crystal layer 13 side, of TFT substrate 11 is directly covered with alignment film 23.

Alignment film 23 is made of a resin material such as polyimide for regulating the initial alignment of liquid crystal molecules in liquid crystal layer 13. Alignment film material 24 has its viscosity lowered by a solvent added to polyimide for example. As alignment film material 24, a vertical alignment film material with a viscosity of 6.5 mPa·s manufactured by JSR Corporation, for example, can be applied.

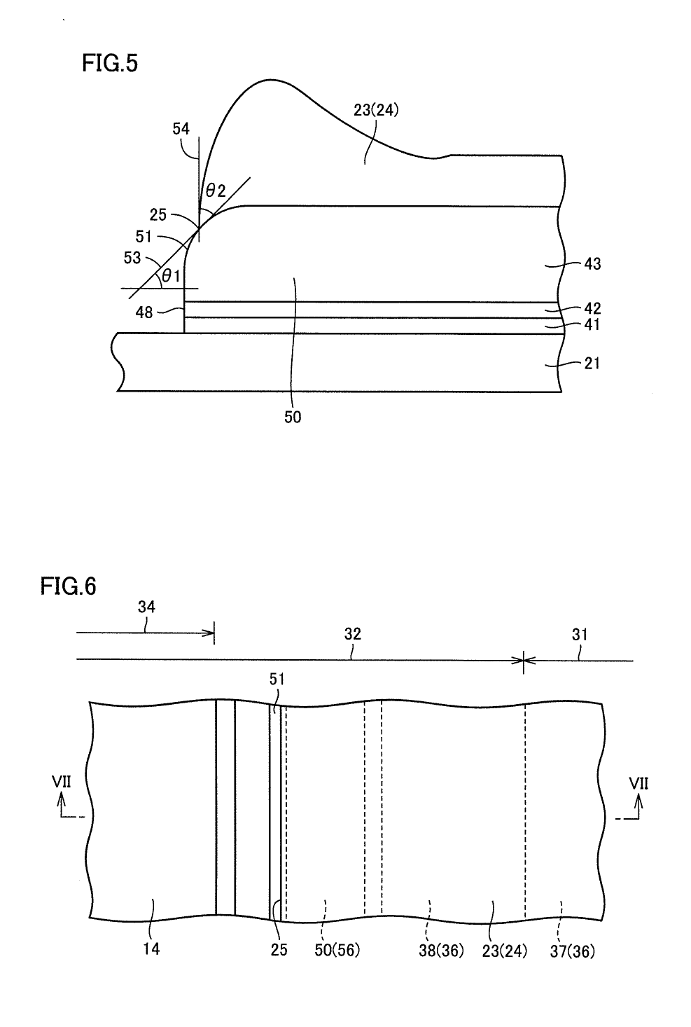

FIG. 5 is a cross-sectional view showing, in an enlarged form, support structure 50 in TFT substrate 11. Support structure 50 has a side 51 that is formed as shown in FIG. 5 in such a manner that a tangent plane 53 which meets the surface of side 51 inclines toward glass substrate 21 and to the outside of support structure 50 (namely toward seal-member-formed region 34, which is located on the left side in FIG. 5). Side 51 of support structure 50 is located between pixel region 31 and a plurality of terminals 28 (particularly between pixel region 31 and seal-member-formed region 34 in the present embodiment) and supports an edge 25 of alignment film 23 and alignment film material 24.

The angle formed between the surface of glass substrate 21 and tangent plane 53 which meets side 51 at edge 25 of alignment film 23/alignment film material 24 is represented by θ1, and the angle formed between tangent plane 53 and a tangent plane 54 which meets, at edge 25 of alignment film 23/alignment film material 24, the surface of edge 25 is represented by θ2.

Since tangent plane 53 of side 51 inclines at angle θ1, alignment film material 24 flowing from the direction of pixel region 31 can be stopped at angle θ2 at side 51. Consequently, alignment film 23 and alignment film material 24 bulge toward liquid crystal layer 13 in the vicinity of side 51 of support structure 50.

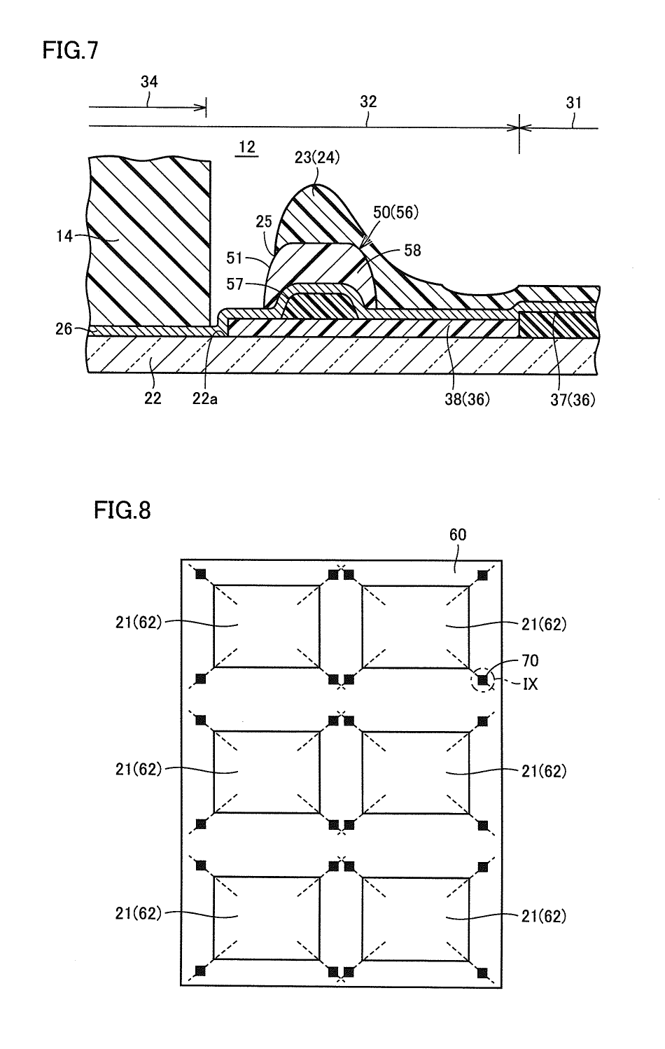

FIG. 6 is a plan view showing, in an enlarged form, a part of opposite substrate 12. FIG. 7 is a cross-sectional view of the part of opposite substrate 12 along a line VII-VII shown in FIG. 6. As shown in FIGS. 6 and 7, opposite substrate 12 has a glass substrate 22 which is a support substrate. Glass substrate 22 has a surface 22a on the liquid crystal layer 13 side. On this surface 22a, a plurality of coloring layers 37 and a black matrix 38 which is a light shielding film are formed to constitute a color filter 36. Black matrix 38 has a thickness of approximately 1.5 μm. On surface 22a, common electrode 26 formed of a transparent conductive film such as ITO is also formed with a thickness of approximately 100 nm.

Coloring layers 37 are each a filter transmitting R (red), G (green), or B (blue) light, and arranged in the form of a matrix in pixel region 31 of opposite substrate 12. Black matrix 38 is formed to prevent light from penetrating between coloring layers 37 adjacent to each other and also prevent light from penetrating through border region 32. Seal member 14 is the same as the one formed on TFT substrate 11, and disposed in seal-member-formed region 34 of border region 32.

On the liquid crystal layer 13 side of opposite substrate 12 as well, alignment film material 24, which is the same as the one formed on TFT substrate 11, is cured to form alignment film 23 which is formed to spread from pixel region 31 toward seal-member-formed region 34. A surface 12a (see FIG. 1), on the liquid crystal layer 13 side, of opposite substrate 12 is directly covered with alignment film 23.

Opposite substrate 12 includes, similarly to TFT substrate 11, a support structure 50 formed therein. Support structure 50 is provided in the vicinity of seal-member-formed region 34 and formed of a protrusion 56 extending in the form of a rib along seal member 14.

Protrusion 56 has a base portion 57 made of the same material as, for example, blue coloring layer 37, and a cover portion 58 covering base portion 57. Cover portion 58 is made of a photosensitive acrylic resin which is the same material as a rib (not shown) or photospacer (not shown) formed in opposite substrate 12 for controlling liquid crystal molecules so that they are vertically aligned.

Support structure 50 of opposite substrate 12 also has a side 51 similar to that of support structure 50 of TFT substrate 11. Side 51 of support structure 50 in opposite substrate 12 is also located between pixel region 31 and seal-member-formed region 34. Alignment film 23 and alignment film material 24 also have an edge 25 supported similarly by side 51.

FIG. 8 is a schematic diagram of a mother glass 60 from which TFT substrate 11 is formed. When TFT substrate 11 is to be manufactured, commonly a large glass plate called mother glass 60 is cut to thereby form a plurality of glass substrates 21. FIG. 8 shows an example where six TFT substrates 11 are formed from one mother glass 60. In FIG. 8, regions of mother glass 60 that correspond to glass substrates 21 are each identified as a thin-film-formed region 62. Mother glass 60 serves as an inkjet printing substrate having its surface 61 (see FIG. 10 described later herein) on which a thin film is printed by means of the inkjet method. A thin film, which is typically gate insulating film 41, passivation film 42, planarization film 43, alignment film 23, or the like, is formed within thin-film-formed region 62, and accordingly a plurality of TFT substrates 11 are fabricated.

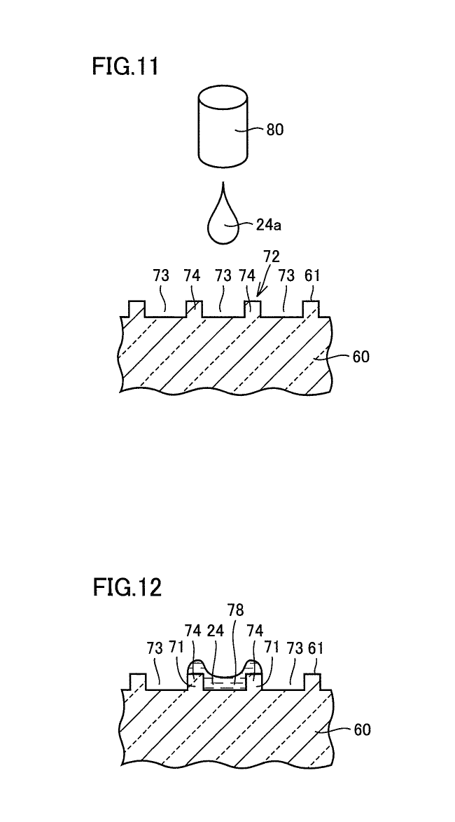

As shown in FIG. 8, thin-film-formed region 62 is formed so that its two-dimensional shape is the shape of a rectangle. In the vicinity of an apex of the rectangle, an alignment mark 70 is disposed outside thin-film-formed region 62. Alignment mark 70 serves as a position identifier for identifying a position, in surface 61 of mother glass 60, on which a droplet of a thin-film material forming a thin film (for example, a droplet 24a of alignment film material 24 forming alignment film 23 shown in FIG. 11) is to be dropped.

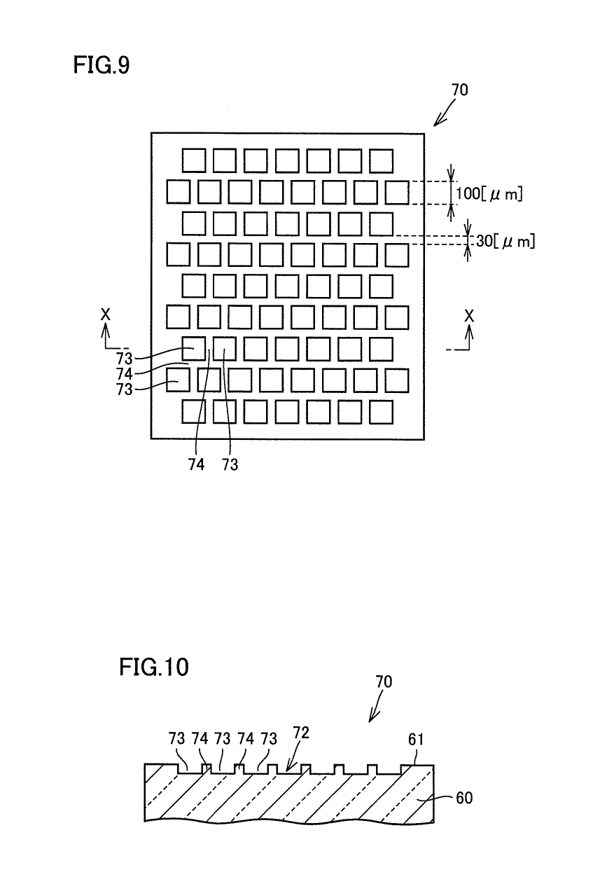

FIG. 9 is an enlarged view of a region IX shown in FIG. 8. FIG. 10 is a cross-sectional view of alignment mark 70 along a line X-X shown in FIG. 9. As clearly shown in FIG. 10, alignment mark 70 includes a depression-protrusion shape 72 into which a part of surface 61 of mother glass 60 is processed to be formed. More specifically, in depression-protrusion shape 72, a plurality of island-like depressions 73 formed by depressing a part of surface 61 are two-dimensionally planarly arranged. Depression-protrusion shape 72 is made up of a plurality of depressions 73 formed by removing a part of surface 61 of mother glass 60 and a ridge-like portion 74 provided between depressions 73 adjacent to each other and raised relative to depressions 73. “Island-like” herein means that a plurality of depressions 73 are not connected to each other but arranged discontinuously. Since depressions 73 are formed like islands, ridge-like portion 74 is formed to surround the perimeter of depression 73.

As shown in FIG. 9, depressions 73 are each formed to have a square two-dimensional shape. A plurality of depressions 73 are formed so that they are aligned along one direction (the left-right direction in FIG. 9). The plurality of depressions 73 are arranged linearly so that they extend along this one direction. Groups of linearly-arranged depressions 73 are arranged in order along the other direction (the top-bottom direction in FIG. 9) which is orthogonal to the above-referenced one direction. In this way, two-dimensionally extending alignment mark 70 shown in FIG. 9 is formed.

Ridge-like portion 74 extends linearly along the above-referenced one direction over the whole of alignment mark 70, and separates from each other the groups of depressions 73 that are aligned along the other direction. Ridge-like portion 74 extending along the other direction is separated into small sections each having a length corresponding to the length of one depression 73 along the other direction. Referring to FIG. 9, regarding the groups of depressions 73 arranged along the other direction, ridge-like portions 74 formed in the groups of depressions 73 in every other row are located at the same position with respect to the above-referenced one direction. Regarding depressions 73 in two rows arranged along the other direction, ridge-like portion 74 formed between depressions 73 in one of the rows is located at a central position, with respect to the above-referenced one direction, between respective positions where two ridge-like portions 74 are located that are formed between depressions 73 in the other row and arranged along the above-referenced one direction.

The square formed by depression 73 may have a length of its one side of 100 μm. Ridge-like portion 74 has its line width which is smaller than the length of one side of depression 73 and may for example be 30 μm.

FIG. 11 is a schematic diagram showing a state where droplet 24a of a thin-film material is being dropped onto alignment mark 70 shown in FIGS. 8 to 10. FIG. 12 is a schematic diagram showing the thin-film material attaching to alignment mark 70. Droplet 24a of the thin-film material having flowability with which an application device 80 is charged is to be dropped onto the position on surface 61 of mother glass 60 where alignment mark 70 is formed as shown in FIG. 11. In FIG. 12, there is shown a state where this droplet 24a lands in depression 73. Since the thin-film material (alignment film material 24 in the example shown in FIG. 12) has low viscosity and high flowability, alignment film material 24 partially overflows from depression 73 in which droplet 24a has landed and flows onto the top of ridge-like portion 74 as shown in FIG. 12.

Alignment film material 24 tends to further flow from ridge-like portion 74 into adjacent depression 73. However, as described above with reference to FIG. 5, alignment film material 24 is supported by ridge-like portion 74 and thereby stopped by ridge-like portion 74 to accordingly bulge from surface 61 of mother glass 60. Depression 73 and ridge-like portion 74 of alignment mark 70 serve as a blocking portion 71 blocking the flow, along surface 61, of droplet 24a of alignment film material 24 having been dropped on surface 61 of mother glass 60. Blocking portion 71 includes depression-protrusion shape 72 formed in a part of surface 61 to thereby suppress spread of the thin-film material along surface 61. Consequently, a marking 78, to which alignment film material 24 forming alignment film 23 has been fed, is formed in a part of depression-protrusion shape 72 of alignment mark 70.

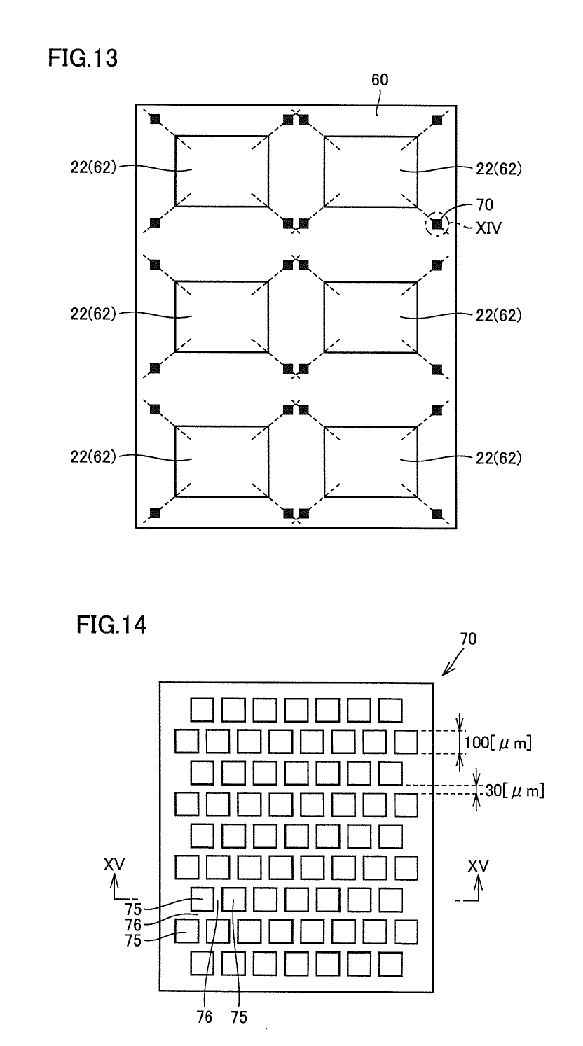

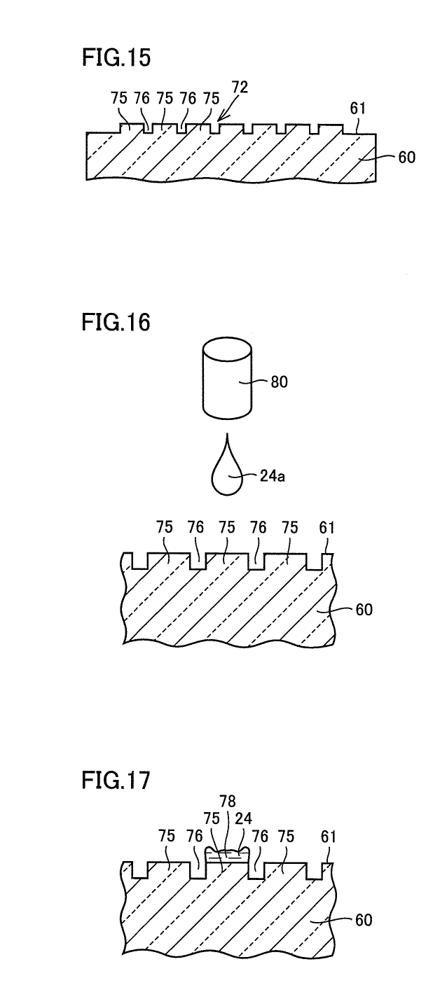

FIG. 13 is a schematic diagram of a mother glass 60 from which opposite substrate 12 is formed. Like mother glass 60 from which TFT substrate 11 is formed as described above, mother glass 60 from which opposite substrate 12 is formed as shown in FIG. 13 serves as an inkjet printing substrate having its surface 61 (see FIG. 15 described later herein) on which a thin film is printed by means of the inkjet method. Six opposite substrates 12 are formed from one mother glass 60. Regions of mother glass 60 that correspond to glass substrates 22 are each identified as a thin-film-formed region 62.

In the vicinity of an apex of thin-film-formed region 62 having a rectangular two-dimensional shape, an alignment mark 70 is disposed outside thin-film-formed region 62. Alignment mark 70 serves as a position identifier for identifying a position in surface 61 of mother glass 60 on which a droplet of a thin-film material forming a thin film (for example, a droplet 24a of alignment film material 24 forming alignment film 23 shown in FIG. 16) is to be dropped.

FIG. 14 is an enlarged view of a region XIV shown in FIG. 13. FIG. 15 is a cross-sectional view of alignment mark 70 along a line XV-XV shown in FIG. 14. As clearly shown in FIG. 15, alignment mark 70 includes a depression-protrusion shape 72 into which a part of surface 61 of mother glass 60 is processed to be formed. More specifically, in depression-protrusion shape 72, a plurality of island-like protrusions 75 formed by protruding a part of surface 61 are two-dimensionally planarly arranged. Depression-protrusion shape 72 is made up of a plurality of protrusions 75 formed by protruding a part of surface 61 of mother glass 60 and a groove-like portion 76 provided between protrusions 75 adjacent to each other and recessed relative to protrusions 75. Since protrusions 75 are formed like islands, grove-like portion 76 is formed to surround the perimeter of protrusion 75.

Alignment mark 70 formed in opposite substrate 12 has the recessed portions and the protruded portions that are contrary to those of alignment mark 70 in TFT substrate 11 described above. Alignment mark 70 of opposite substrate 12 shown in FIG. 14 has its shape in a plan view similar to that of alignment mark 70 of TFT substrate 11 described above with reference to FIG. 9. Protrusions 75 are each formed in the shape of a square in a plan view. The square formed by protrusion 75 may have each side of 100 μm in length. The line width of groove-like portion 76 is smaller than the length of each side of protrusion 75 and may, for example, be 30 μm.

FIG. 16 is a schematic diagram showing a state where a droplet 24a of a thin-film material is being dropped onto alignment mark 70 shown in FIGS. 13 to 15. FIG. 17 is a schematic diagram showing the thin-film material attaching to alignment mark 70. Droplet 24a of the thin-film material having flowability with which an application device 80 is charged is to be dropped onto the position on surface 61 of mother glass 60 where alignment mark 70 is formed as shown in FIG. 16. In FIG. 17, there is shown a state where this droplet 24a lands on the top surface of protrusion 75.

Since the thin-film material (alignment film material 24 in the example shown in FIG. 17) has low viscosity and high flowability, the material is likely to flow from protrusion 75 on which droplet 24a has landed, toward groove-like portion 76 surrounding, in the form of a frame, the perimeter of protrusion 75, as shown in FIG. 12. However, as described above with reference to FIG. 5, alignment film material 24 is supported by the side of protrusion 75 and thereby stopped. Protrusion 75 and groove-like portion 76 of alignment mark 70 serve as a blocking portion 71 blocking the flow, along surface 61, of droplet 24a of alignment film material 24 having been dropped on surface 61 of mother glass 60. Blocking portion 71 includes depression-protrusion shape 72 formed in a part of surface 61 to thereby suppress spread of the thin-film material along surface 61. Consequently, a marking 78, to which alignment film material 24 forming alignment film 23 has been fed, is formed in a part of depression-protrusion shape 72 of alignment mark 70.

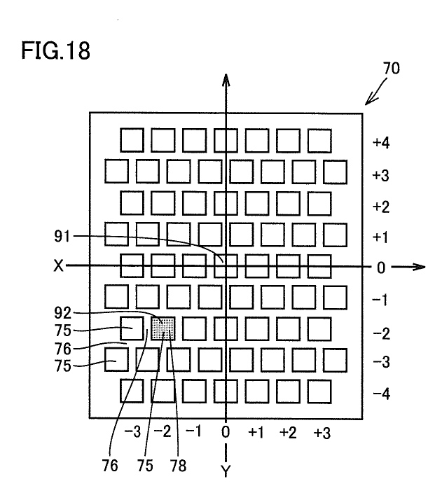

FIG. 18 is a schematic diagram showing a target position 91 on which droplet 24a is to be dropped in alignment mark 70 and a landing position 92 onto which droplet 24a has landed. FIG. 18 shows, by way of example, alignment mark 70 formed in opposite substrate 12. The point of intersection of an X axis and a Y axis which are two axes orthogonal to each other as shown in FIG. 18 represents a target center position onto which droplet 24a of alignment film material 24 is to be landed, and this position is referred to as target position 91. Meanwhile, the position where droplet 24a has actually been dropped on surface 61 of mother glass 60 is referred to as landing position 92. In depression-protrusion shape 72 of alignment mark 70, a coordinate system indicating respective positions of a plurality of island-like protrusions 75 is defined. In the example shown in FIG. 18, the coordinates of target position 91 are (0, 0), and the coordinates of landing position 92 are (−2, −2). This coordinate system can be formed by black matrix 38 in the case of opposite substrate 12. In the case of TFT substrate 11, the coordinate system can be formed by gate lines, source lines, or a silicon layer.

As shown in FIG. 18, with respect to target position 91 on which the thin-film material is intended to be dropped, landing position 92 deviates in both the X axis direction and the Y axis direction. The coordinate system shown in FIG. 18 can be provided on alignment mark 70 to thereby confirm immediately whether or not landing position 92 is deviated from target position 91. The amount of deviation of landing position 92 from target position 91 can be detected and corrected to thereby enable the thin-film material to be applied accurately on the substrate surface by means of the ink jet method. In this way, a thin film such as alignment film 23 can be formed more accurately in two-dimensional respect. Since the accuracy of positioning alignment film material 24 to be supplied to the substrate surface by means of the ink jet method can be improved, alignment film material 24 can accurately be applied to glass substrate 21, 22 so that seal member 14 and alignment film material 24 do not overlap each other even if the interval between seal member 14 and pixel region 31 is shortened. Accordingly, the slim border of liquid crystal display device 1 can be achieved.

Since alignment mark 70, which is used for detecting the deviation of landing position 92 from target position 91 of alignment film material 24, is disposed outside thin-film-formed region 62, alignment mark 70 will not hinder attachment of a terminal or wire when liquid crystal display device 1 is being formed. A preferred structure is as follows. Specifically, rectangular thin-film-formed region 62 is formed to have its corners of 90° at respective apexes and, on an imaginary line drown to divide the corner of 90° into two equal halves of 45° each, alignment marks 70 are formed so that alignment marks 70 are point symmetry with respect to thin-film-formed region 62. This structure is preferred since the thin-film material can be applied with still higher precision.

In the following, a method for manufacturing above-described liquid crystal display device 1 will be described. Liquid crystal display device 1 is manufactured in the following way. Frame-like seal member 14 is formed on TFT substrate 11 or opposite substrate 12, a liquid crystal is dropped inside this seal member 14, and thereafter TFT substrate 11 and opposite substrate 12 are attached to each other. Two mother glasses 60, 60 shown in FIGS. 8 and 13 are attached together so that respective positions of respective thin-film-formed regions 62 match each other, and the laminate of mother glasses 60 is cut into and thus fabricate liquid crystal display devices 1.

TFT substrate 11 is manufactured in the following way. First, on a surface of glass substrate 21 which is a transparent substrate, gate lines (not shown), gate insulating film 41, a silicon film (not shown), source lines 16, passivation film 42, and planarization film 43 are formed. After this, the photolithography method and etching are used to form a plurality of depressions 48 extending through planarization film 43, passivation film 42, and gate insulating film 41. In depression 48, glass substrate 21 is exposed if there is no underlying metal layer. Thus, support structure 50 is formed as a part of planarization film 43.

Simultaneously with this step of forming depressions 48, depressions 73 are formed. Accordingly, alignment mark 70 with which the range of extension of alignment film material 24 can be controlled is formed. Since depressions 73 can be formed simultaneously with formation of depressions 48, no additional step for forming depressions 73 is necessary, and the productivity of TFT substrate 11 can be prevented from deteriorating.

Next, on the surface of planarization film 43, an ITO layer is formed and is patterned by means of photolithography and etching to thereby form a plurality of pixel electrodes 15.

Subsequently, target position 91 is set on alignment mark 70 before alignment film material 24 is applied to pixel region 31, and then droplet 24a of alignment film material 24 is dropped toward target position 91, which is a position where droplet 24a should be dropped on alignment mark 70. Landing position 92 onto which the dropped droplet 24a has actually landed is detected, and a positional deviation of landing position 92 from target position 91 is detected. Then, setting of application device 80 for alignment film material 24 is changed so that the positional deviation is reduced (typically the amount of positional deviation is reduced to zero). After this, alignment film material 24 having flowability such as polyimide is applied by means of the inkjet method so that the material covers components such as pixel electrode 15 as described above. Each time alignment film material 24 is patterned on glass substrate 21, alignment mark 70 is monitored. Thus, the process can be monitored to see whether or not application device 80 is positionally displaced.

Alignment film material 24 flows from pixel region 31 into border region 32 to reach side 51 of support structure 50. At this time, edge 25 of alignment film material 24 is supported by this side 51. As a result, as shown in FIG. 3, alignment film material 24 bulges toward liquid crystal layer 13 and thus stopped in the vicinity of side 51 of support structure 50. After this, alignment film material 24 is baked to form alignment film 23.

Opposite substrate 12 is manufactured in the following way. On the surface of glass substrate 22 which is a transparent substrate, common electrode 26 and color filter 36 are formed. Here, simultaneously with formation of coloring layers 37 of color filter 36, base portion 57 is formed of the same material as coloring layers 37, on the surface of black matrix 38 in border region 32. Simultaneously, protrusions 75 are formed. Accordingly, alignment mark 70 with which the range of extension of alignment film material 24 can be controlled is formed. Since protrusions 75 can be formed simultaneously with formation of coloring layers 37, no additional step for forming protrusions 75 is necessary, and the productivity of opposite substrate 12 can be prevented from deteriorating.

Next, a photosensitive acrylic resin for example is deposited to cover base portion 57 and color filter 36, and thereafter subjected to photolithography and then developed. Thus, cover portion 58 which covers base portion 57 and a photospacer (not shown) or a rib for controlling liquid crystal molecules so that they are vertically aligned are formed simultaneously.

Subsequently, target position 91 is set on alignment mark 70 before alignment film material 24 is applied to pixel region 31, and then droplet 24a of alignment film material 24 is dropped toward target position 91, which is a position where droplet 24a should be dropped on alignment mark 70. Landing position 92 onto which the dropped droplet 24a has actually landed is detected, and a positional deviation of landing position 92 from target position 91 is calculated. Then, setting of application device 80 for alignment film material 24 is changed so that the positional deviation is reduced (typically the amount of positional deviation is reduced to zero). After this, alignment film material 24 having flowability such as polyimide is applied by means of the inkjet method so that the material covers components such as color filter 36 as described above.

Alignment film material 24 flows from pixel region 31 into border region 32 to reach side 51 of support structure 50. At this time, edge 25 of alignment film material 24 is supported by this side 51. As a result, as shown in FIG. 7, alignment film material 24 bulges toward liquid crystal layer 13 and thus stopped in the vicinity of side 51 of support structure 50. After this, alignment film material 24 is baked to form alignment film 23.

As seen from the foregoing description, prior to inkjet application of alignment film material 24 which has high flowability, droplet 24a of alignment film material 24 is dropped on alignment mark 70 and a positional deviation of landing position 92 from target position 91 is adjusted. Accordingly, highly precise inkjet application of alignment film material 24 can be achieved. When liquid crystal display device 1 of the slim border type having a narrowed interval between pixel region 31 and seal member 14 is to be manufactured, alignment film 23 can be disposed with high accuracy in two-dimensional respect, and therefore, seal member 14 and alignment film material 24 can be prevented from overlapping each other and the adhesion of seal member 14 can be ensured.

Alignment mark 70 formed in mother glass 60 of TFT substrate 11 may be formed through formation of the gate lines, silicon layer or source lines, or formation of a contact hole in a photosensitive acrylic resin which is an interlayer insulating film. Alignment mark 70 formed in mother glass 60 of opposite substrate 12 may be formed through formation of the coloring layer such as black matrix, or the rib or photospacer provided for controlling liquid crystal alignment.

### Second Embodiment

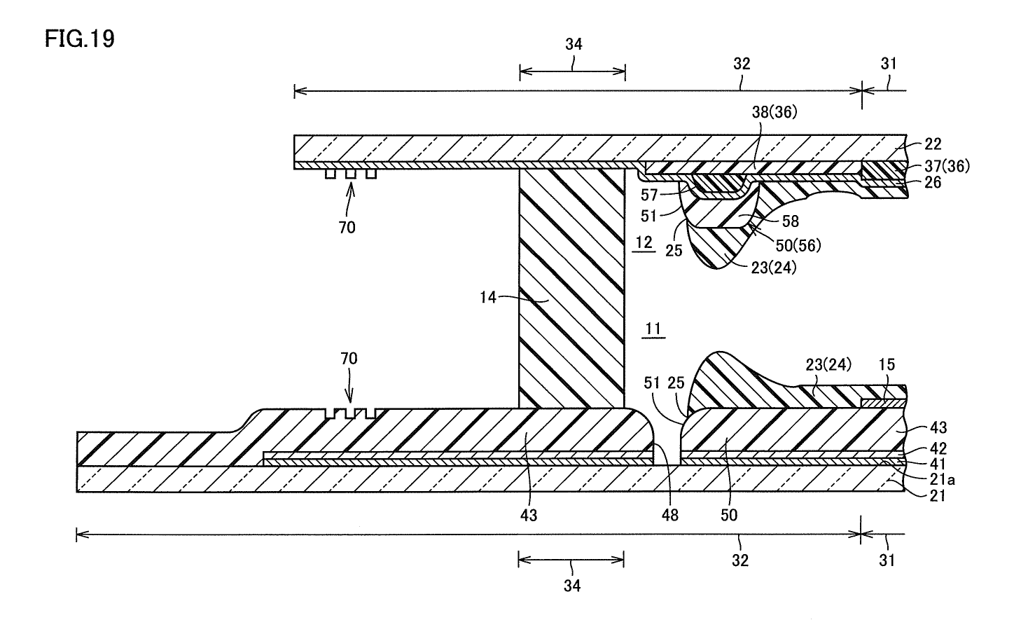

FIG. 19 is a cross-sectional view showing a general configuration of a liquid crystal display device in a second embodiment. The liquid crystal display device of the second embodiment has a similar configuration to that of above-described liquid crystal display device 1. The second embodiment, however, differs from the first embodiment in that alignment mark 70, which serves as a positional identifier for identifying a position where droplet 24a of alignment film material 24 is to be dropped, is formed in border regions 32 of TFT substrate 11 and opposite substrate 12, and in that alignment mark 70 has a blocking portion 71 which blocks flow, along the surface, of droplet 24a having been dropped on surface 11a of TFT substrate 11 and surface 12a of opposite substrate 12.

In the first embodiment, alignment mark 70 is formed outside thin-film-formed region 62 of mother glass 60 and thus alignment mark 70 does not appear on liquid crystal display device 1 in the form of a completed product. In contrast, the liquid crystal display device of the second embodiment includes alignment mark 70 in border regions 32 of TFT substrate 11 and opposite substrate 12 as shown in FIG. 19. This configuration of the second embodiment still enables improvement of the accuracy of positioning alignment film material 24 which is applied by means of the inkjet method, like the first embodiment. Since alignment mark 70 is formed at a position still closer to pixel region 31 where alignment film 23 is to be formed, the accuracy of positioning alignment film 23 can further be improved.

In the example shown in FIG. 19, both TFT substrate 11 and opposite substrate 12 have respective alignment marks 70 formed therein. However, alignment mark 70 may be formed in one of TFT substrate 11 and opposite substrate 12.

While the above description of the first and second embodiments has been given of an example where alignment film material 24 is applied by means of the inkjet method to TFT substrate 11 and opposite substrate 12 of liquid crystal display device 1, the present invention is not limited to this use. For example, in the case where another thin film such as coloring layer 37 is to be formed on the surface of glass substrate 21, 22 as well, alignment mark 70 described in connection with the first and second embodiments can be applied to enable accurate inkjet application of the thin-film material.

Further, the present invention is applicable not only to liquid crystal display device 1 but also any use as long as a thin-film material with high flowability is to be applied by means of the inkjet method, such as ink which is dropped to land a substrate surface thereafter spreads to a greater extent than a required accuracy. For example, the present invention is applicable to application of a resist film for a semiconductor device.

It should be construed that the embodiments disclosed herein are by way of illustration in all respects, not by way of limitation. It is intended that the scope of the present invention is defined by claims, not by the description above, and encompasses all modifications and variations equivalent in meaning and scope to the claims.

### REFERENCE SIGNS LIST

1 liquid crystal display device; 11 TFT substrate; 11a, 12a surface; 12 opposite substrate; 14 seal member; 21, 22 glass substrate; 23 alignment film; 24 alignment film material; 24a droplet; 31 pixel region; 32 border region; 60 mother glass; 61 surface; 62 thin-film-formed region; 70 alignment mark; 71 blocking portion; 72 depression-protrusion shape; 73 depression; 74 ridge-like portion 75 protrusion; 76 groove-like portion; 80 application device; 91 target position; 92 landing position

1. A substrate having a surface with a thin film to be formed on said surface,
said substrate including a depression-protrusion shape in which a plurality of island-like depressions or protrusions formed in said surface are two-dimensionally arranged, and
a marking to which a thin-film material forming said thin film is fed being formed in a part of said depression-protrusion shape.

2. The substrate according to claim 1, wherein said depression-protrusion shape is formed by depressing a part of said surface.

3. The substrate according to claim 1, wherein said depression-protrusion shape is formed by protruding a part of said surface.

4. The substrate according to claim 1, wherein
said substrate has a thin-film-formed region where said thin film is to be formed on said substrate, and
said depression-protrusion shape is disposed outside said thin-film-formed region.

5. The substrate according to claim 1, wherein a coordinate system indicating respective positions of said plurality of island-like depressions or protrusions is defined in said depression-protrusion shape.

6. A liquid crystal display device comprising:
a pair of substrates disposed opposite to each other; and
a liquid crystal layer disposed between said pair of substrates,
said substrates each including a display region where an image is to be displayed and a border region around an outer perimeter of said display region,
said substrates each having a surface facing said liquid crystal layer and an alignment film which is a cured form of an alignment film material having flowability being formed on said surface,
said surface of at least one of said pair of substrates having a depression-protrusion shape in which a plurality of island-like depressions or protrusions are two-dimensionally arranged, and
a marking to which said alignment film material forming said alignment film is fed being formed in a part of said depression-protrusion shape.
